(19) United States
(12) Patent Application Publication
(10) Pub. No.: US 2025/0129656 A1
(43) Pub. Date: Apr. 24, 2025

(54) AUTOMATIC GARAGE DOOR CONTROL SYSTEM AND METHOD BASED ON ATS TIMETABLE

(71) Applicant: CASCO SIGNAL LTD., Shanghai (CN)

(72) Inventors: Sheng WANG, Shanghai (CN); Xingyu FENG, Shanghai (CN); Shujie LIU, Shanghai (CN); Lanxiang WANG, Shanghai (CN); Juan XIE, Shanghai (CN); Gongjian ZHOU, Shanghai (CN); Luyao QIAO, Shanghai (CN)

(21) Appl. No.: 18/836,292

(22) PCT Filed: Nov. 30, 2022
(86) PCT No.: PCT/CN2022/135653

§ 371 Date: Aug. 6, 2024

(30) Foreign Application Priority Data
Jul. 27, 2022 (CN) 202210889826.2

(51) Int. Cl. E05F 15/79; E05F 15/40

(52) U.S. Cl. CPC E05F 15/79; E05F 15/40; E05Y 2900/106; E05Y 2900/132

(57) ABSTRACT

The invention relates to an Automatic garage door control system and method based on ats timetable, which are used for implementing remote automatic control of garage doors. The ATS timetable-based automatic control system comprises a garage door plan management module, a garage door information maintenance module and a garage door control processing module, wherein the garage door control processing module outputs garage door control commands and alarm events according to times calculated by the garage door plan management module and garage door basic information provided by the garage door information maintenance module. Compared with the prior art, the invention realizes automatic processing, provides multiple options, and is good in timeliness and practicability.

### BACKGROUND OF THE INVENTION

### 1. Technical Field

The invention relates to the driverless field, in particular to an Automatic garage door control system and method based on ats timetable.

### 2. Description of Related Art

Existing urban rail transit projects rarely involve remote automatic control of garage doors and mostly focus on local manual control.

In driverless projects, in order to improve the automation level of systems to free up manpower, save energy, or timely open and close garage doors to protect to some extent related equipment in winter in cities in northern China, it is necessary to realize remote automatic control of garage doors.

The opening and closing of garage doors are closely related to entry and exit of trains, and the ATS timetable defines specific entry and exit time information of trains, so how to realize remote automatic control of garage doors based on the ATS timetable becomes a technical issue to be addressed.

### BRIEF SUMMARY OF THE INVENTION

The objective of the invention is to overcome the abovementioned defects existing in the prior art by providing an Automatic garage door control system and method based on ats timetable, which realize automatic processing, provide multiple options, and are good in timeliness and practicability.

The objective of the invention can be fulfilled by the following technical solution:

In a first aspect, the invention provides an Automatic garage door control system based on ats timetable, which is used for implementing remote automatic control of garage doors and comprises a garage door plan management module, a garage door information maintenance module and a garage door control processing module, wherein the garage door control processing module outputs garage door control commands and alarm events according to times calculated by the garage door plan management module and garage door basic information provided by the garage door information maintenance module.

As a preferred technical solution, the garage door plan management module is used for maintaining on-line and off-line times of corresponding trains on a parking line, updating the on-line and off-line times according to entry and exit plans of one day and changes of the entry and exit plans of said day, and handling real-time events of the trains when the trains return to a garage.

As a preferred technical solution, the garage door information maintenance module is used for saving a corresponding relationship between garage doors and parking lines, as well as basic information of garage door devices.

As a preferred technical solution, the garage door control processing module is a control logic processing unit, is respectively connected to the garage door plan management module and the garage door information maintenance module and transmits information.

In a second aspect, the invention provides a method using the Automatic garage door control system based on ats timetable, which processes garage door open times by the following steps:
Step 1.1, reading all entry and exit plans from a database;
Step 1.2, traversing each entry and exit plan;
Step 1.3, if there is no entry and exit plan, directly skipping to the end; otherwise, performing Step 1.4;
Step 1.4, obtaining parking line node information and an on-line time according to the entry and exit plan;
Step 1.5, obtaining section object information, including an existing time and a garage door object, according to a serial number of a main station where a parking line node is located;
Step 1.6, comparing the time obtained in Step 1.4 with the existing time of a section of the main station obtained in Step 1.5, and updating the batch open time;
Step 1.7, obtaining the garage door object in the section according to the parking line node in Step 1.5; and
Step 1.8, updating an open time of the garage door object obtained in Step 1.7, and returning to Step 1.2.

As a preferred technical solution, an automatic control mode of garage doors is opening in batches, opening separately or opening garage doors when trains return to a garage.

As a preferred technical solution, in a case where the automatic control mode of garage doors is opening in batches, a logic of the method comprises:
acquiring an earliest garage door open time and a pre-open time threshold; if a current system time is within a defined garage door pre-open time range, popping up an alarm with a countdown, and instantly sending, by the system, a garage door batch open command; if an operator turns off an automatic batch open option within the garage door pre-open time range, not automatically opening garage doors in batches at the end of the countdown.

As a preferred technical solution, in the case where the automatic control mode of door garages is opening in batches, the method specifically comprises the following steps:
Step 2.1, obtaining an earliest door garage open time DepotStartTime and a current system time SystemTime;
Step 2.2, checking periodically; if the system time SystemTime satisfies the following condition:
system time>=earliest garage door open time−pre-alarm time and system time<=earliest garage door open time−pre-alarm time+garage door open time range, giving a garage door batch-open alarm;
Step 2.3, checking periodically; if the system time SystemTime satisfies the following condition:
system time>=earliest garage door open time−pre-alarm time+garage door open delay time after alarm and system time<=earliest garage door open time−pre-alarm time+garage door open delay time after the alarm+garage door open time range, and a current option is automatic open enabled, performing Step 2.4; if the current option is automatic open disabled, ending the process; and
Step 2.4, checking a related entry and exit plan; if there is a train that enters or exits the garage along a parking line corresponding to a garage door, automatically sending a command for opening the garage door.

As a preferred technical solution, in a case where the automatic control mode of garage doors is opening independently, the logic of the method comprises:
acquiring an exit time of a train on a parking line in the entry and exit plan and a pre-open time threshold; if a current system time is within a defined garage door pre-open time range, popping up an alarm with a countdown, and instantly sending, by the system, a command for opening a garage door corresponding to the parking line; if an operator turns off a garage door automatic open option within the garage door pre-open time range, not sending the command for automatically opening the garage door at the end of the countdown.

As a preferred technical solution, in the case where the automatic control mode of garage doors is opening independently, the method specifically comprises the following steps:
Step 3.1, acquiring an open time GDStartTime of each garage door and a current system time SystemTime;
Step 3.2, checking periodically; if the system time SystemTime satisfies the following condition:
system time>=open time of each garage door−pre-alarm time and system time>=open time of each garage door−pre-alarm time+garage door open time range, giving a garage door open alarm;
Step 3.3, checking periodically; if the system time SystemTime satisfies the following condition:
system time>=open time of each garage door−pre-alarm time+garage door open delay time after alarm and system time>=open time of each garage door−pre-alarm time+garage door open delay time after alarm+garage door open time range, and a current option is automatic open enabled, performing Step 3.4; if the current option is automatic open disabled, ending the process; and
Step 3.4, automatically sending an open garage door command.

As a preferred technical solution, in a case where the automatic control mode of garage doors is opening garage doors when trains return to a garage, a logic of the method comprises:
when the trains arrive at a transfer track, acquiring an arrival position of a parking line in a return plan corresponding to the group of trains, and checking whether garage doors associated with the parking line are in a closed state; if the garage doors associated with the parking line are in both the closed state and a locked state, popping up an alarm with a countdown, and instantly sending, by the system, a command for opening the garage doors corresponding to the parking line; and if an operator turns off a garage door automatic open option, not sending the command for opening the garage doors at the end of the countdown.

As a preferred technical solution, in a case where the automatic control mode of garage doors is opening garage doors when trains return to a garage, the method specifically comprises the following steps:
Step 4.1, when a train operates to a transfer track, obtaining an entry plan corresponding to the train;
Step 4.2, inquiring a garage door corresponding to the parking line according to the parking line in the entry plan;
Step 4.3, checking whether the garage door is in a closed and locked state; if not, ending the process; and
Step 4.4, automatically sending a command for opening the garage door, and giving an alarm at the same time.

In a third aspect, the invention provides an electronic device, comprising a memory and a processor, wherein a computer program is stored in the memory, and when executing the computer program, the processor implements the method mentioned above.

In a fourth aspect, the invention provides a computer-readable storage medium having a computer program stored therein, wherein the method mentioned above is implemented when the computer program is executed by a processor.

Compared with the prior art, the invention has the following advances:
1. The invention designs the method and basic principle for opening garage doors and provides multiple scenarios which can be selected according to personal requirements, such that the application range of the invention is greatly expanded;
2. The invention associates the open time of garage doors with entry and exit plans, thus guaranteeing the timeliness to some extent;
3. The invention provides automatic operation measures, thus liberating part of operators and improving the practicability of systems;
4. In addition to automatic control measures, the invention also provides manual intervention measures in abnormal scenarios and generates alarms to remind operators at any time, thus avoiding undesired actions.

### BRIEF DESCRIPTION OF THE SEVERAL VIEWS OF THE DRAWINGS

FIG. 1 is a schematic structural diagram of an automatic control system for garage doors;

FIG. 2 is a flow diagram for processing the open time of garage doors according to the invention;

FIG. 3 is a flow diagram of opening garage doors in batches according to the invention;

FIG. 4 is a flow diagram of opening garages doors separately according to the invention;

FIG. 5 is a flow diagram of openings garage doors when trains return to a garage according to the invention.

### DETAILED DESCRIPTION OF THE INVENTION

The technical solutions of the embodiments of the invention will be clearly and completely described below in conjunction with the accompanying drawings of the embodiments of the invention. Obviously, the embodiments in the following description are merely illustrative ones, and are not all possible ones of the invention. All other embodiments obtained by those ordinarily skilled in the art according to the following ones without creative labor shall also fall within the protection scope of the invention.

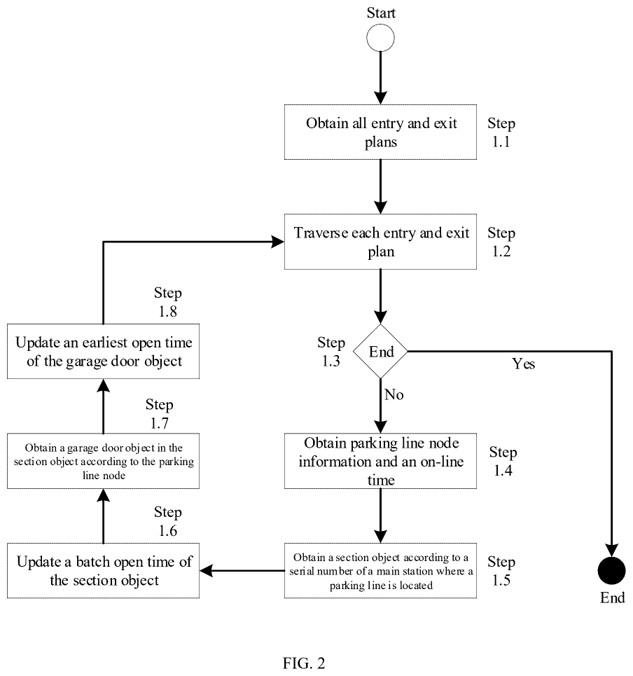

As shown in FIG. 2, the invention provides a method using an Automatic garage door control system based on ats timetable. The method processes garage door open times by the following steps:
Step 1.1: reading all entry and exit plans from a database;
Step 1.2: traversing each entry and exit plan;
Step 1.3: if there is no entry and exit plan, directly skipping to the end; otherwise, performing Step 1.4;
Step 1.4: obtaining parking line node information and an on-line time according to the entry and exit plan;
Step 1.5: obtaining a section object according to a serial number of a main station where a parking line node is located;
Step 1.6: comparing the time obtained in Step 1.4 with an existing time of the section object obtained in Step 1.5, and updating a new batch open time;
Step 1.7: obtaining a garage door object in the section object according to the parking line node in Step 1.5;
Step 1.8: updating an open time of the garage door object obtained in Step 1.7; and
repeating Step 1.2 until there is no entry and exit plan.

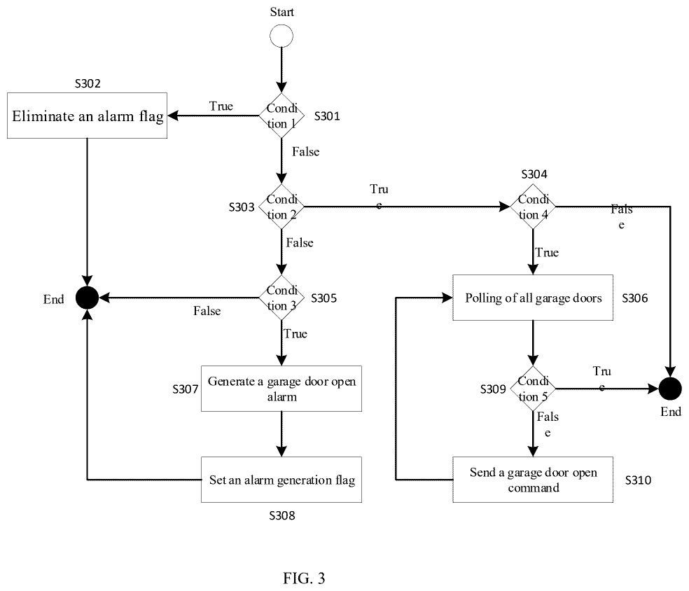

As shown in FIG. 3, in a case where an automatic control mode of garage doors is opening in baches, the logic of the method comprises the following steps:
Condition 1: whether a system time SystemTime satisfies:
System Time>DepotStartTime-PreOpenGDAlarmTime+OpenGDAfterAlarmTime+OpenGDTimeDuration;
Condition 2: whether a variable openAlarm is true, wherein openAlarm is an open alarm flag;
Condition 3: whether the system time SystemTime satisfies:
[DepotStartTime-PreOpenGDAlarmTime, DepotStartTime-PreOpenGDAlarmTime+OpenGDTimeDuration];
Condition 4: whether the system time SystemTime satisfies:
[DepotStartTime-PreOpenGDAlarmTime+OpenGDAfterAlarmTime, DepotStartTime-PreOpenGDAlarmTime+OpenGDTimeDuration]; OpenGDAfterAlarmTime+
Condition 5: whether garage door polling ends;
Step S301: checking the condition 1; if the condition 1 is true, skipping to
Step S302; if the condition 1 is false, skipping to Step S303:
Step S302: eliminating the alarm flag, and ending the process;
Step S303, checking the condition 2; if the condition 2 is true, skipping to Step S304; if the condition 2 is false, skipping to Step S305;
Step S304: checking the condition 4; if the condition 4 is false, directly ending the process; if the condition 4 is true, skipping to Step S306;
Step S305: checking the condition 3; if the condition 3 is false, directly ending the process; if the condition 3 is true, skipping to Step S307;
Step S306: polling all garage doors, and then skipping to Step S309;
Step S307: generating the garage door open alarm;
Step S308: setting an alarm generation flag openAlarm to be true, and ending the process;
Step S309: checking the condition 5; if the condition 5 is true, ending the process; if the condition 5 is false, skipping to Step S310; and
Step S310: sending a garage door open instruction, and skipping to Step S306.

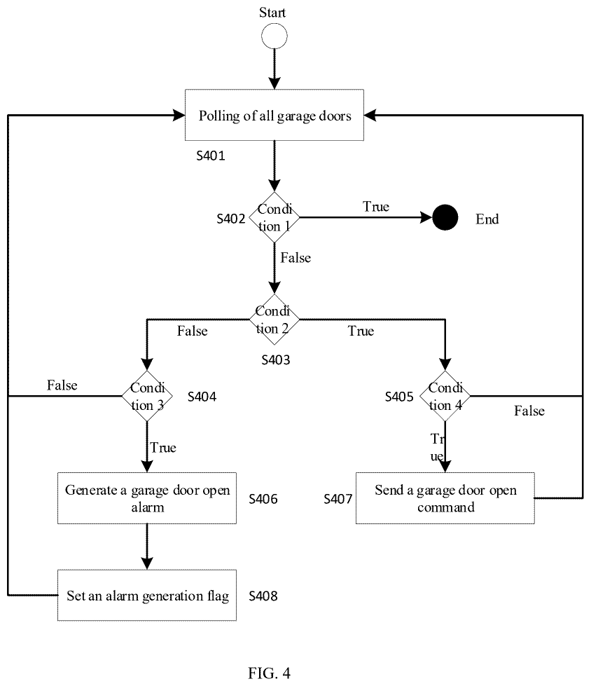

As shown in FIG. 4, when the automatic control mode of garage doors is opening separately, the logic of the method comprises the following steps:

```
  while (get garageDoor from depot) // Step S401
  {
    If(garageDoor is not NULL) // Step S402
    {
      Break;
    }
    Else if(openAlarmFlag == TRUE)// Step S403
    {
      If(system Time >= DepotStartTime-PreOpenGD AlarmTime
  && system Time <= DepotStartTime-PreOpenGDAlarmTime+
OpenGDTimeDuration)// Step S405
      {
        SendOpenGarageDoorCommand;// Step S407
      }
      Else
      {
        Break;
      }
    }
    Else if(systemTime >= DepotStartTime-PreOpenGDAlarmTime+
OpenGDAfterAlarmTime
  &&  system Time <= DepotStartTime-PreOpenGDAlarmTime+
OpenGDAfterAlarmTime+ OpenGDTimeDuration)
    // Step S404
    {
      GenerateOpenAlarm;// Step S406
      SetOpenAlarmFlag;//step S408
    }
  }
```

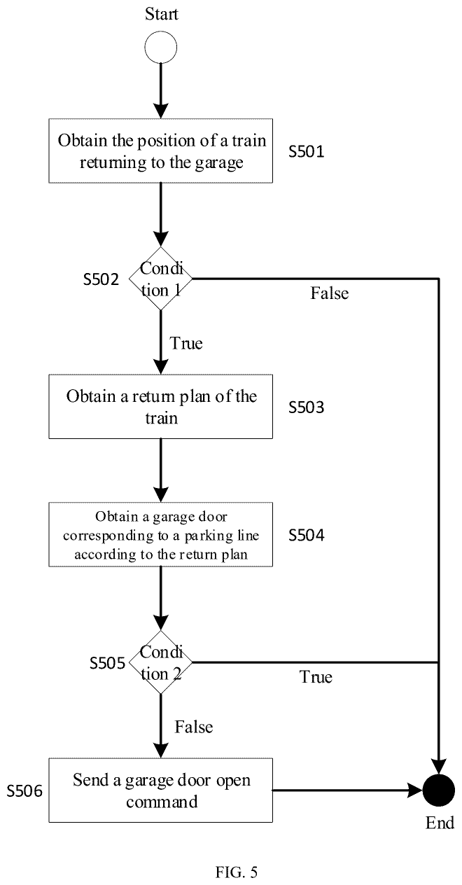

As shown in FIG. 5, when the automatic control mode of garage doors is opening garage doors when trains return into a garage, the logic of the method comprises the following steps:
Step S501: tracking and obtaining the position of a train returning to the garage:
Step S502: if a condition 1 is false, directly ending the process: if the condition is true, skipping to Step S503, wherein the condition 1 is whether the train is located on a transfer track:
Step S503: obtaining a return plan of the train returning to the garage:
S504: obtaining a corresponding garage door object according to an arrival position in the return plan of the train;
Step S505: if a condition 2 is true, directly ending the process: if the condition 2 is false, skipping to Step S506; wherein, the condition 2 is whether the garage door object obtained in Step S504 is in an open state; and
Step S506: sending a garage door open command, and then ending the process.

The embodiment of the method is introduced above, and the technical solution of the invention will be further explained below with reference to an embodiment of a system.

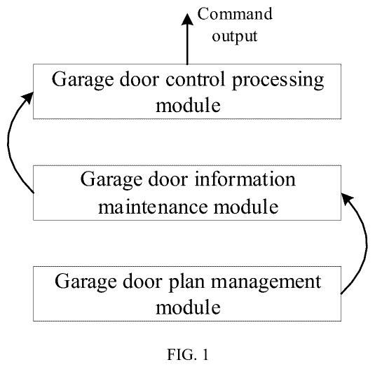

As shown in FIG. 1, an ATS timetable-based automatic control systems for garage doors is used for implementing remote automatic control of garage doors and comprises a garage door plan management module, a garage door information maintenance module and a garage door control processing module, wherein the garage door control processing module outputs garage door control commands and alarm events according to times calculated by the garage door plan management module and garage door basic information provided by the garage door information maintenance module.

The garage door control processing module is a control logic processing unit and transmits information based on the garage door plan management module and the garage door information maintenance module. The specific processing process of the garage door control processing module comprises:
Step S1, recognizing an automatic control mode of garage doors: if the automatic control mode of garage door is control in batches, performing Step S2; otherwise, performing Step S3;
Step S2, acquiring an earliest garage door open time and a pre-open time threshold; if a current system time is within a defined garage door pre-open time range, popping up an alarm with a countdown, and instantly sending, by the system, a garage door batch open command: if an operator turns off an automatic batch open option within the garage door pre-open time range, not automatically opening garage doors in batches at the end of the countdown;
Step S3, acquiring an exit time of a train on a parking line in an entry and exit plan and a pre-open time threshold; if a current system time is within a defined garage door pre-open time range, popping up an alarm with a countdown, and instantly sending, by the system, a command for opening a garage door corresponding to the parking line: if an operator turns off a garage door automatic open option within the garage door pre-open time range, not sending the command for automatically opening the garage door at the end of the countdown; and
Step S4, when trains arrive at a transfer track, acquiring an arrival position of a parking line in a return plan corresponding to the group of trains, and checking whether garage doors associated with the parking line are in a closed state: if the garage doors associated with the parking line are in both the closed state and a locked state, popping up an alarm with a countdown, and instantly sending, by the system, a command for opening the garage doors corresponding to the parking line; and if an operator turns off a garage door automatic open option, not sending the command for opening the garage doors at the end of the countdown.

The garage door plan management module is used for maintaining on-line and off-line times of corresponding trains on a parking line, updating the on-line and off-line times according to entry and exit plans of one day and changes of the entry and exit plans of said day, and handling real-time events of the trains when the trains return to a garage. The specific processing process of the garage door plan management module comprises:
Step S5, in case of a change of an entry and exit plan, refreshing a garage door open time; and
Step S6, if it is recognized that the automatic control mode of garage doors is control in batches, calculating an earliest time in an exit plan of a current section, and saving the earliest time locally: if it is recognized that the automatic control mode of garage doors is control separately, calculating and saving exit times of trains on each parking line in the exit plan.

The garage door information maintenance module is used for saving a corresponding relationship between garage doors and parking lines, as well as basic information of garage door devices.

Those skilled in the art can clearly know that, to facilitate and simplifying the description, the specific operating processes of the modules described above can be understood with reference to corresponding processes in the embodiment of the method mentioned above and will not be repeated here.

An electronic device provided by the invention comprises a central processing unit (CPU), which can perform various appropriate actions and processing according to computer program instructions stored in a read only memory (ROM) or computer program instructions loaded into a random access memory (RAM) from a storage unit. Various programs and data required for operations of the device can also be stored in the RAM. The CPU, ROM and RAM are connected by means of a bus. An input/output (I/O) interface is also connected to the bus.

Multiple components in the device are connected to the I/O interface, including an input unit such as a keyboard or a mouse: an output unit such as various displays or speakers: a storage unit such as a magnetic disk or a compact disc; and a communication unit such as a network card, a modem or a wireless communication transceiver. The communication unit allows the device to exchange information/data with other devices by means of, for example, computer networks based on the internet and/or various telecommunication networks.

The processing unit performs the steps and processing described above, such as the method S1-S6. For example, in some embodiments, the method S1-S6 can be implemented as a computer software program, which is tangibly stored in a machine-readable medium such as the storage unit. In some other embodiments, the computer program may be partially or entirely loaded and/or installed on the device by means of the ROM and/or the communication unit. When the computer program is loaded into the RAM and executed by the CPU, one or more of the steps of the method S1-S6 described above can be performed. Alternatively, in other embodiments, the CPU can be configured to implement the method S1-S6 in any other appropriate ways (such as, by means of firmware).

At least part of the functions described above can be performed by one or more hardware logic components. For example, non-restrictively, illustrative hardware logic components that can be used include: a field programmable gate array (FPGA), an application-specific integrated circuit (ASIC), an application-specific standard product (ASSP), a system on chip (SOC), a complex programmable logic device (CPLD), and the like.

Program codes for implementing the method of the invention may be written in one programming language or any combination of multiple programming languages. These program codes can be provided to a processor or a controller of a general-purpose computer, a special-purpose computer or other programmable data processing devices, such that when the program codes are executed by the processor or controller, the functions/operations specified in the flow diagram and/or block diagram are performed. The program codes may be entirely executed on a machine, partially executed on a machine, partially executed on a machine as an independent software package and partially executed on a remote machine, or entirely executed on a remote machine or server.

In the context of the invention, the machine-readable medium may be a tangible medium, and may comprise or store a program, which is used by or in conjunction with an instruction execution system, apparatus or device. The machine-readable medium may be a machine-readable flagal medium or a machine-readable storage medium. The machine-readable medium may comprise, but is not limited to, electronic, magnetic, optical, electromagnetic, infrared or semiconductor systems, apparatuses or devices, or any suitable combinations thereof. More specific examples of the machine-readable storage medium comprise an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any combinations thereof.

The above embodiments are merely specific ones of the invention, and the protection scope of the invention is not limited to the above embodiments. Any skilled in the art can easily think out various equivalent modifications or substitutions within the technical scope disclosed by the invention, and all these equivalent modifications or substitutions should fall within the protection scope of the invention. Therefore, the protection scope of the invention should be subject to the protection scope of the claims.

1. An Automatic garage door control system based on ats timetable, being used for implementing remote automatic control of garage doors, wherein the ATS timetable-based automatic control system comprises a garage door plan management module, a garage door information maintenance module and a garage door control processing module, wherein the garage door control processing module outputs garage door control commands and alarm events according to times calculated by the garage door plan management module and garage door basic information provided by the garage door information maintenance module.

2. The Automatic garage door control system based on ats timetable according to claim 1, wherein the garage door plan management module is used for maintaining on-line and off-line times of corresponding trains on a parking line, updating the on-line and off-line times according to entry and exit plans of one day and changes of the entry and exit plans of said day, and handling real-time events of the trains when the trains return to a garage.

3. The Automatic garage door control system based on ats timetable according to claim 1, wherein the garage door information maintenance module is used for saving a corresponding relationship between garage doors and parking lines, as well as basic information of garage door devices.

4. The Automatic garage door control system based on ats timetable according to claim 1, wherein the garage door control processing module is a control logic processing unit, is respectively connected to the garage door plan management module and the garage door information maintenance module and transmits information.

5. A method using the Automatic garage door control system based on ats timetable according to claim 1, wherein the method processes garage door open times by the following steps:
Step 1.1, reading all entry and exit plans from a database;
Step 1.2, traversing each entry and exit plan;
Step 1.3, if there is no entry and exit plan, directly skipping to the end; otherwise, performing Step 1.4;
Step 1.4, obtaining parking line node information and an on-line time according to the entry and exit plan;
Step 1.5, obtaining section object information, including an existing time and a garage door object, according to a serial number of a main station where a parking line node is located;
Step 1.6, comparing the time obtained in Step 1.4 with the existing time of a section of the main station obtained in Step 1.5, and updating a new batch open time;
Step 1.7, obtaining the garage door object in the section according to the parking line node in Step 1.5; and
Step 1.8, updating an open time of the garage door object obtained in Step 1.7, and returning to Step 1.2.

6. The method according to claim 5, wherein an automatic control mode of garage doors is opening in batches, opening separately or opening garage doors when trains return to a garage.

7. The method according to claim 6, wherein in a case where the automatic control mode of garage doors is opening in batches, a logic of the method comprises:
acquiring an earliest garage door open time and a pre-open time threshold; if a current system time is within a defined garage door pre-open time range, popping up an alarm with a countdown, and instantly sending, by the system, a garage door batch open command; if an operator turns off an automatic batch open option within the garage door pre-open time range, not automatically opening garage doors in batches at the end of the countdown.

8. The method according to claim 7, wherein in the case where the automatic control mode of door garages is opening in batches, the method specifically comprises the following steps:
Step 2.1, obtaining an earliest door garage open time DepotStartTime and a current system time System Time;
Step 2.2, checking periodically; if the system time SystemTime satisfies the following condition:
system time>=earliest garage door open time−pre-alarm time and system time<=earliest garage door open time−pre-alarm time+garage door open time range, giving a garage door batch-open alarm;
Step 2.3, checking periodically; if the system time SystemTime satisfies the following condition:
system time>=earliest garage door open time−pre-alarm time+garage door open delay time after alarm and system time<=earliest garage door open time−pre-alarm time+garage door open delay time after the alarm+garage door open time range, and a current option is automatic open enabled, performing Step 2.4; if the current option is automatic open disabled, ending the process; and
Step 2.4, checking a related entry and exit plan; if there is a train that enters or exits the garage along a parking line corresponding to a garage door, automatically sending a command for opening the garage door.

9. The method according to claim 6, wherein in a case where the automatic control mode of garage doors is opening independently, a logic of the method comprises:
acquiring an exit time of a train on a parking line in the entry and exit plan and a pre-open time threshold; if a current system time is within a defined garage door pre-open time range, popping up an alarm with a countdown, and instantly sending, by the system, a command for opening a garage door corresponding to the parking line; if an operator turns off a garage door automatic open option within the garage door pre-open time range, not sending the command for automatically opening the garage door at the end of the countdown.

10. The method according to claim 9, wherein in the case where the automatic control mode of garage doors is opening independently, the method specifically comprises the following steps:
Step 3.1, acquiring an open time GDStartTime of each garage door and a current system time System Time;
Step 3.2, checking periodically; if the system time SystemTime satisfies the following condition:
system time>=open time of each garage door−pre-alarm time and system time>=open time of each garage door−pre-alarm time+garage door open time range, giving a garage door open alarm;
Step 3.3, checking periodically; if the system time SystemTime satisfies the following condition:
system time>=open time of each garage door−pre-alarm time+garage door open delay time after alarm and system time>=open time of each garage door−pre-alarm time+garage door open delay time after alarm+garage door open time range, and a current option is automatic open enabled, performing Step 3.4; if the current option is automatic open disabled, ending the process; and
Step 3.4, automatically sending an open garage door command.

11. The method according to claim 6, wherein in a case where the automatic control mode of garage doors is opening garage doors when trains return to a garage, a logic of the method comprises:
when the trains arrive at a transfer track, acquiring an arrival position of a parking line in a return plan corresponding to the group of trains, and checking whether garage doors associated with the parking line are in a closed state; if the garage doors associated with the parking line are in both the closed state and a locked state, popping up an alarm with a countdown, and instantly sending, by the system, a command for opening the garage doors corresponding to the parking line; and if an operator turns off a garage door automatic open option, not sending the command for opening the garage doors at the end of the countdown.

12. The method according to claim 11, wherein in a case where the automatic control mode of garage doors is opening garage doors when trains return to a garage, the method specifically comprises the following steps:
Step 4.1, when a train operates to a transfer track, obtaining an entry plan corresponding to the train;
Step 4.2, inquiring a garage door corresponding to the parking line according to the parking line in the entry plan;
Step 4.3, checking whether the garage door is in a closed and locked state; if not, ending the process; and
Step 4.4, automatically sending a command for opening the garage door, and giving an alarm at the same time.

13. An electronic device, comprising a memory and a processor, a computer program being stored in the memory, wherein the method according to claim 5 is implemented when the processor executes the computer program.

14. A computer-readable storage medium, having a computer program stored therein, wherein the method according to claim 5 is implemented when the computer program is executed by a processor.
